(19) United States
(12) Patent Application Publication
(10) Pub. No.: US 2014/0036514 A1
(43) Pub. Date: Feb. 6, 2014

(54) LED LIGHTING UNIT

(71) Applicant: YAZAKI CORPORATION, Tokyo (JP)

(72) Inventor: Masahiro SAWAYANAGI, Makinohara-shi (JP)

(73) Assignee: YAZAKI CORPORATION, Tokyo (JP)

(21) Appl. No.: 14/047,069

(22) Filed: Oct. 7, 2013

Related U.S. Application Data
(63) Continuation of application No. PCT/JP2012/060095, filed on Apr. 6, 2012.

(30) Foreign Application Priority Data
Apr. 8, 2011 (JP) 2011-086507

(51) Int. Cl. F21V 31/00

(52) U.S. Cl. CPC F21V 31/005
USPC 362/368; 362/362

(57) ABSTRACT

An LED lighting unit includes a housing, a circuit board and a seal member. The seal member includes a seal main body inserted into the housing in an insertion direction, a wire insertion portion, a protrusion piece protruded from a rear surface of the seal main body opposite to the insertion direction. A holder is arranged at a side of an opening of the housing relative to the seal member and includes a guide base inserted into the housing, a protruded wire guide portion protruded from a front end surface of the guide base and arranged at a position facing the wire insertion portion within the housing, and a wire lead portion leading the electric wire from a position adjacent to the guide base to an external. The opened surface of the housing coincides with a rear end surface of the guide base at within the housing.

### CROSS REFERENCE TO RELATED APPLICATIONS

This application is a continuation of PCT application No. PCT/JP2012/060095, which was filed on Apr. 6, 2012 based on Japanese Patent Application (No. 2011-086507) filed on Apr. 8, 2011, the contents of which are incorporated herein by reference.

### BACKGROUND OF THE INVENTION

1. Field of the Invention

The present invention is related to an LED lighting unit in which a circuit board having an LED (light emitting diode) element mounted thereon is accommodated within a housing.

2. Description of the Related Art

In the LED lighting unit in which a circuit board having the LED element mounted thereon is accommodated within the housing, an electric wire having one end connected to the circuit board is led to the external from an opening of the housing while maintaining a waterproof performance. Thus, a seal material for maintaining the waterproof performance within the housing is required to lead the electric wire from contents within the housing. Accordingly, a number of parts is increased, and an assembling work becomes complicated. Under the circumstances, for example PTL1 proposes a fixing structure for an crimping terminal that surely fixes an crimping terminal and the seal material to an crimping connector in a lump, and a seal member.

### CITATION LIST

[Patent Literature]

[PTL1] JP-A-2004-356013

### SUMMARY OF THE INVENTION

The fixing structure for the crimping terminal and the seal member disclosed in PTL1 includes a connector housing, the crimping terminal, the seal member, and a terminal holding member. The seal member is caught to a tip of a protrusion in a state where the crimping terminal is fixedly attached to the connector housing, and an engagement piece of the terminal holding member is accommodated into a terminal accommodation hole of the terminal holding member. With this configuration, the seal member is fixedly engaged to a connector fitting portion.

However, the fixing structure for the crimping terminal and the seal member disclosed in PTL1 is a structure in which an electric wire is bent and held so that no external force is applied to a connection of the electric wire and the circuit board, that is, a so-called strain relief structure. Therefore, the electric wire must be held in the connector housing after the electric wire has been bent, resulting in such a problem that the assembling work is complicated.

It is therefore one advantageous aspect of the present invention to provide an LED lighting unit that can facilitate the assembling work while maintaining the waterproof performance and reducing an external load on the connection of the electric wire and the circuit board.

According to one advantage of the invention, there is provided an LED lighting unit, comprising:

a housing which has a box shape including an opened surface formed with an opening and which is made of a light transmissive material;

a circuit board on which an LED element is mounted so that at least one electric wire having one end connected to the circuit board is led to external from the opening of the housing;

a seal member, arranged at a side of the opening relative to the circuit board, and including:
a seal main body configured to be inserted into the housing in an insertion direction;
a wire insertion portion formed with an insertion hole through which the electric wire to be inserted into the seal main body in the insertion direction;
a protrusion piece arranged at adjacent to the wire insertion portion, and protruded from a rear surface of the seal main body in a direction opposite to the insertion direction; and

a holder, arranged at a side of the opening of the housing relative to the seal member, and including:
a guide base configured to be inserted into the housing;
a protruded wire guide portion, protruded from a front end surface of the guide base in the insertion direction, and arranged at a position facing the wire insertion portion within the housing; and
a wire lead portion, configured to lead the electric wire from a position adjacent to the guide base to an external thereof,

wherein the opened surface of the housing coincides with a rear end surface of the guide base at a position within the housing.

The LED lighting unit may be configured such that: the protruded wire guide portion has a wire guide groove, the wire guide groove has a curved surface having a cross section corresponding to a diameter of the electric wire, and when the guide base is inserted into the housing, the wire guide groove is arranged to face the insertion hole.

The LED lighting unit may be configured such that: the housing includes a fixed portion configured to be fixed to a fitting surface of an object to be fitted by a fastening member, and in a state where the fixed portion is fixed to the fitting surface, the rear end surface of the guide base comes in contact with the fitting surface of the object to be fitted so that the holder is arranged at a position within the housing.

In the LED lighting unit according to the present invention, when the fitting work of the housing has been completed, that is, when the opening end surface of the housing has coincided with the rear end surface of the guide base, the electric wire is held within the housing in a state where the electric wire is bent along the protrusion piece of the seal member, the guide base of the holder, and the protruded wire guide portion. That is, since the strain relief structure is configured by the seal member and the holder with the fitting work of the housing, the assembling work can be facilitated while maintaining the waterproof performance and reducing the external load on the connection of the electric wire and the circuit board.

In the LED lighting unit according to the present invention, the protruded wire guide portion has the wire guide groove whose cross section orthogonal to the longitudinal direction of the electric wire forms the curved surface corresponding to the diameter of the electric wire, and when the guide base is inserted into the housing, the wire guide groove is arranged to face the insertion hole. Therefore, the electric wire can be surely guided by the wire guide groove with the result that a bending direction of the electric wire W can be more surely regulated.

In the LED lighting unit according to the present invention, the housing has the fixed portion fixed to the fitting surface by the fastening member, and when the fixed portion is fixed to the fitting surface by fastening the fastening member, the holder is arranged at the given position within the housing by abutting the rear end surface of the guide base against the fitting surface. This makes easy to install the LED lighting unit.

### BRIEF DESCRIPTION OF THE DRAWINGS

FIG. 1 is an exploded perspective view of an LED lighting unit according to an embodiment of the present invention.

FIG. 2 is a perspective view illustrating the LED lighting unit illustrated in FIG. 1 and a connector connected to the LED lighting unit.

FIGS. 3A and 3B are enlarged views of a main portion of a housing and a holder illustrated in FIG. 1.

FIG. 4 is a diagram illustrating a periphery of a fitting surface of a body to which the LED lighting unit illustrated in FIG. 1 is fitted.

FIGS. 5A and 5B are diagrams illustrating a procedure of assembling the LED lighting unit illustrated in FIG. 1.

FIGS. 6A and 6B are diagrams illustrating the procedure of assembling the LED lighting unit illustrated in FIG. 1.

FIGS. 7A and 7B are diagrams illustrating the procedure of assembling the LED lighting unit illustrated in FIG. 1.

### DETAILED DESCRIPTION OF THE EXEMPLARY EMBODIMENTS

An LED lighting unit according to an embodiment of the present invention will be described in detail with reference to the accompanying drawings.

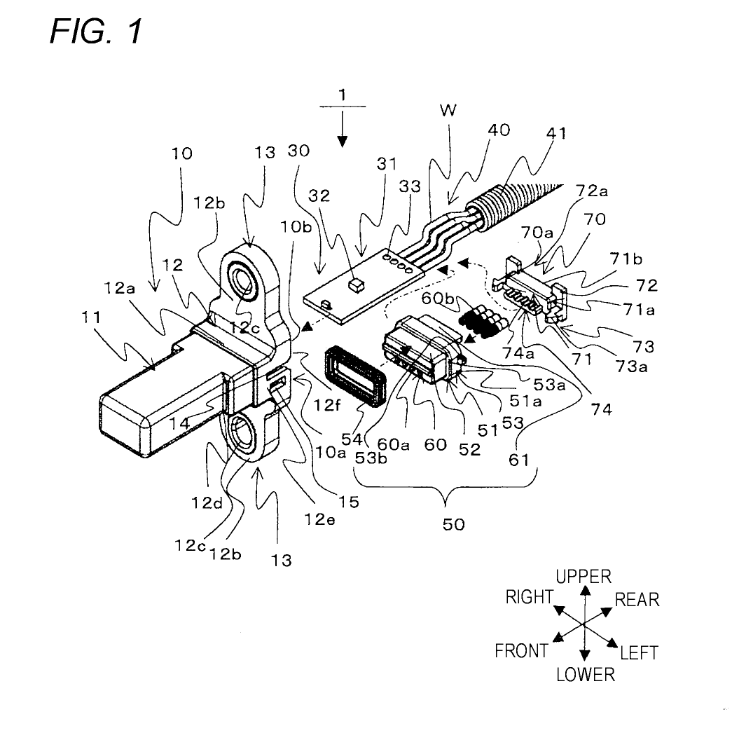

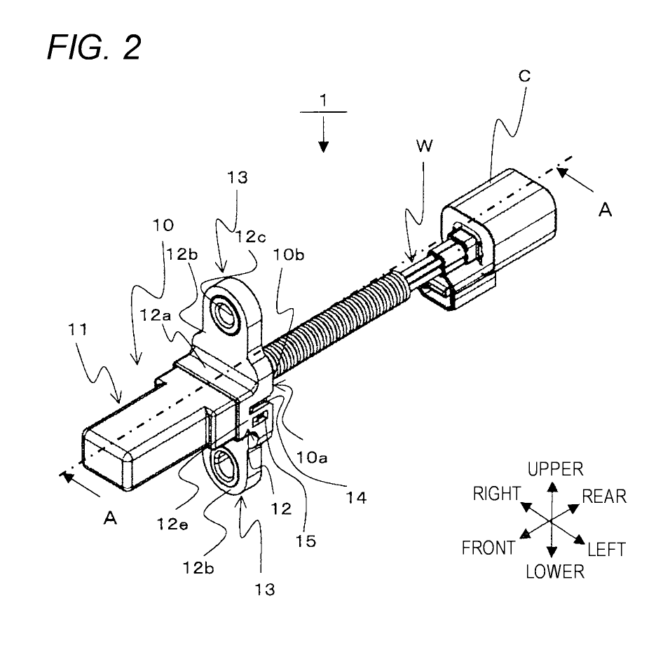

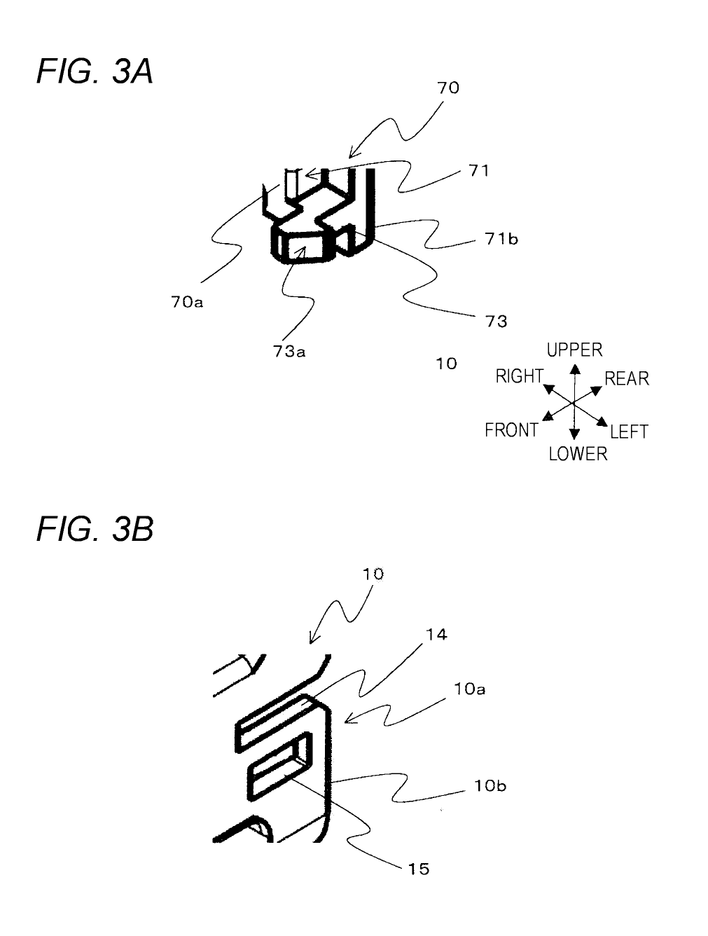

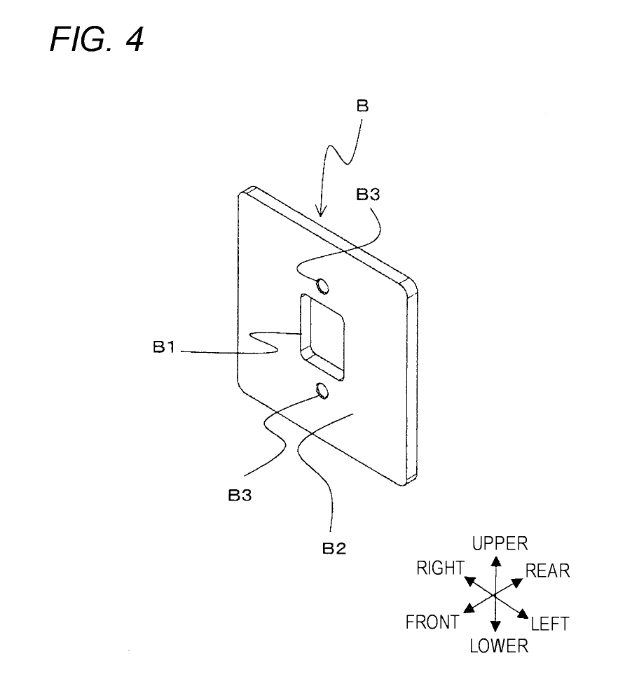

FIG. 1 is an exploded perspective view of an LED lighting unit 1 according to an embodiment of the present invention. FIG. 2 is a perspective view illustrating the LED lighting unit 1 illustrated in FIG. 1 and a connector C connected to the LED lighting unit 1. FIGS. 3A and 3B are enlarged views of a main portion of a housing 10 and a holder 70 illustrated in FIG. 1. FIG. 4 is a diagram illustrating a periphery of a fitting surface B2 of a body B to which the LED lighting unit 1 illustrated in FIG. 1 is fitted.

For convenience, in the drawings, it is assumed that directions of arrows orthogonal to each other are front, rear, left, right, upper, and lower directions.

The LED lighting unit 1 includes the housing 10, an LED lighting portion 30, a wire harness portion 40, a seal member 50, and the holder 70. The LED lighting unit 1 is fitted to a wall of an object to be fitted, for example, the fitting surface B2 in a state where the wire harness portion 40 passes through a wire harness insertion port B1 (refer to FIG. 4) formed in the body B of a vehicle body, and connected to an object to be connected through the connector C connected to a side of the body B through which the wire harness insertion port B1 penetrates.

The housing 10 is formed into a box shape having one surface opened and made of a light transmissive material, and accommodates the LED lighting portion 30 therein. The housing 10 includes a light transmissive portion 11 and an opening end portion 12.

The light transmissive portion 11 is made of a light transmissive material, and transmits a light emitted from an LED element 32 which will be described later to the external.

The opening end portion 12 forms an end of the housing 10 on an opening 10a side thereof. The opening end portion 12 includes a fixed portion 13, a pair of guide slit portions 14, and a pair of housing side engagement portions 15.

The fixed portion 13 is fixed to the fitting surface B2 by a bolt functioning as a fastening member. The fixed portion 13 includes a pair of plate-like protrusions 12b erected upward or downward from the respective outer surfaces of an upper wall 12a and a lower wall 12d of the opening end portion 12, which are disposed opposite to each other. Each of the plate-like protrusions 12b is formed with a bolt hole 12c into which a housing fixing bolt is fitted. The housing 10 is fixed to the fitting surface B2 by inserting the bolt through the bolt hole 12c and a body side bolt hole B3 formed in the body B in correspondence with the bolt hole 12c.

The pair of guide slit portions 14 guides the seal member 50, which will be described later, to a fitting position within the housing 10. The guide slit portions 14 are configured by a pair of slits formed toward the interior of the housing 10 from each opening end 12f of opposed side walls 12e of the opening end portion 12.

The pair of housing side engagement portions 15 is engaged with a pair of holder side engagement portions 73 which will be described later. The pair of housing side engagement portions 15 is configured by a pair of slotted holes formed in the opposed side walls 12e of the opening end portion 12.

The LED lighting portion 30 and the wire harness portion 40 will be described.

The LED lighting portion 30 includes a circuit board 31 and the LED element 32.

The circuit board 31 has the LED element 32 mounted thereon, and is connected to the respective electric wires W of the wire harness portion 40 through terminals 33 formed on the board. The circuit board 31 is realized by a so-called printed wiring board, and has a conductor pattern such as a power supply circuit formed thereon. Also, in this embodiment, the circuit board 31 is connected to those four electric wires W functioning as signal lines or feeders through the terminals 33 formed on the board. The respective electric wires W are connected to the terminals 33 by soldering.

In the LED element 32, a light emitting portion is disposed on an upper surface of a box package, and a power input terminal (not shown) is connected to a power supply circuit (not shown) of the circuit board 31. The power supply circuit (not shown) is connected to the four electric wires W through the terminals 33 disposed on the board. The LED element 32 lights on by supply of a power supply through the power supply circuit.

In the wire harness portion 40, the four electric wires W are bundled by a tube 41.

The seal member 50 will be described.

The seal member 50 includes a seal main body 51, a wire insertion portion 60, and a protrusion piece 61, and is arranged at the opening 10a side relative to the circuit board 31.

The seal main body 51 is configured by a substantially rectangular parallelepiped member which can be inserted into the housing 10, and more particularly whose cross section orthogonal to a longitudinal direction is substantially rectangular.

The seal main body 51 includes a seal member holding portion 52 and a section enlargement portion 53.

The seal member holding portion 52 forms a front side of two front and rear pieces of the seal main body 51 divided in an insertion direction (longitudinal direction) into the housing 10. A cross section of the seal member holding portion 52 which is orthogonal to the longitudinal direction is substantially rectangular, and a size of the rectangular cross section is smaller than that of the section enlargement portion 53. More specifically, a step is formed on a boundary between the seal member holding portion 52 and the section enlargement portion 53 so as to decrease a height of the seal member holding portion 52 side.

An annular seal member 54 is arranged in the outer periphery of the seal member holding portion 52. Thus, in the seal member 50, a gap between the outer periphery of the seal member holding portion 52 and the inner wall surface of the housing 10 is filled with the annular seal member 54 to enhance the waterproof performance.

The section enlargement portion 53 forms a rear side of the two divided front and rear pieces of the seal main body 51. A cross section of the section enlargement portion 53 which is orthogonal to the longitudinal direction is substantially rectangular, and a size of the rectangular cross section is larger than that of the seal member holding portion 52. The section enlargement portion 53 has a pair of protrusions 53b protruded from both of the side surfaces 53a. Each of the pair of protrusions 53b is fitted into each slit of the guide slit portions 14 so that the seal member 50 is guided to the fitting position within the housing 10.

The wire insertion portion 60 has four insertion through-holes 60a formed in parallel so that the four electric wires W are held in parallel. Each of the insertion through-holes 60a accommodates each cylindrical seal member 60b therein. Thus, in the seal member 50, a gap between each electric wire W and each insertion through-hole 60a is filled with the cylindrical seal member 60b to enhance the waterproof performance.

The annular seal member 54 is disposed above the section enlargement portion 53, and protruded rearward from a rear end surface 51a of the seal main body 51 in the longitudinal direction.

The opening 10a of the housing 10 is covered with the seal member 50 thus configured to waterproof the circuit board 31 accommodated within the housing 10.

The holder 70 will be described.

The holder 70 is disposed on the opening 10a side of the housing 10 relative to the seal member 50 to cover the opening 10a of the housing 10. The holder 70 includes a guide base 71 and a protruded wire guide portion 74.

The guide base 71 is configured by a portion which can be inserted into the housing 10, that is, which is a portion whose cross section orthogonal to the longitudinal direction is substantially rectangular, and forms a base of the holder 70. The guide base 71 includes a guide plate 72, and the pair of holder side engagement portions 73.

The guide plate 72 is a plate-like wall erected along a rear end portion 71a of the guide base 71 so as to cover the opening 10a of the housing 10. The guide plate 72 has a wire lead portion 72a.

The wire lead portion 72a is a portion that allows the electric wires W to be led from an upper position of the guide base 71 to the external. More specifically, the wire lead portion 72a is configured so that a partial wall of the guide base 71 at an upper surface position thereof is removed to enable the electric wires W to be led to the external.

As illustrated in FIGS. 3A and 3B, the pair of holder side engagement portions 73 includes hook-like portions 73a that are protruded forward from the guide plate 72 at both sides of the guide base 71, and formed in the form of hooks at the front end. The pair of holder side engagement portions 73 is engaged with the slotted holes of the housing side engagement portions 15, to thereby fix the holder 70 to the housing 10.

The protruded wire guide portion 74 is protruded forward from a front end surface 70a of the guide base 71 in the longitudinal direction, and arranged at a position facing the wire insertion portion 60 when the guide base 71 is inserted into the housing 10. The protruded wire guide portion 74 guides a wiring direction of the four electric wires W. More specifically, the protruded wire guide portion 74 is configured so as to align four wire guide grooves 74a each having a cross section orthogonal to the longitudinal direction of the electric wires W in correspondence with the diameter of the electric wires W. Also, the protruded wire guide portion 74 is configured so that the respective wire guide grooves 74a face the four insertion through-holes 60a in the longitudinal direction when the holder 70 is inserted into the housing 10.

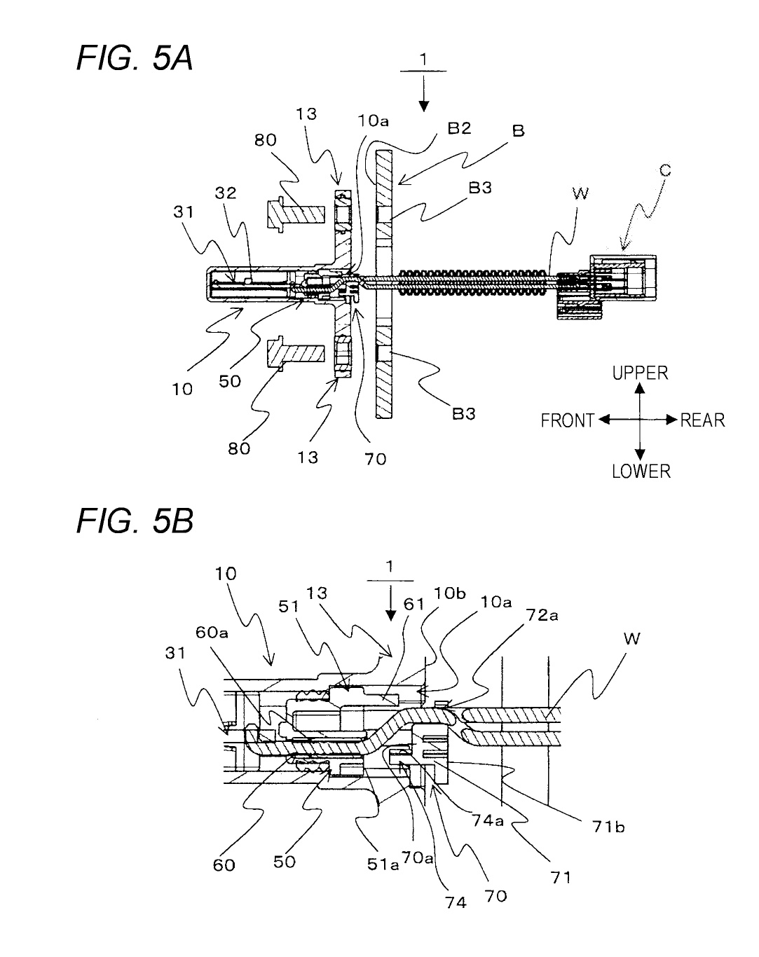

Subsequently, a description will be given of a procedure of assembling the LED lighting unit 1 with reference to FIGS. 5A to 7B. FIGS. 5A to 7B are diagrams illustrating the procedure of assembling the LED lighting unit 1 illustrated in FIG. 1. In those figures, FIGS. 5A, 6A, and 7A are cross-sectional views of the LED lighting unit 1 and the connector C illustrated in FIG. 2 taken along a line A-A, and FIGS. 5B, 6B, and 7B are enlarged views of main portions in FIGS. 5A, 6A, and 7A.

First, an operator inserts the front end of the holder 70 into the housing 10 after the circuit board 31 and the seal member 50 have been fitted to the interior of the housing 10 (refer to FIGS. 5A and 5B). In this example, it is assumed that the respective electric wires W are inserted through the insertion through-holes 60a of the seal member 50 via the four insertion through-holes 60a.

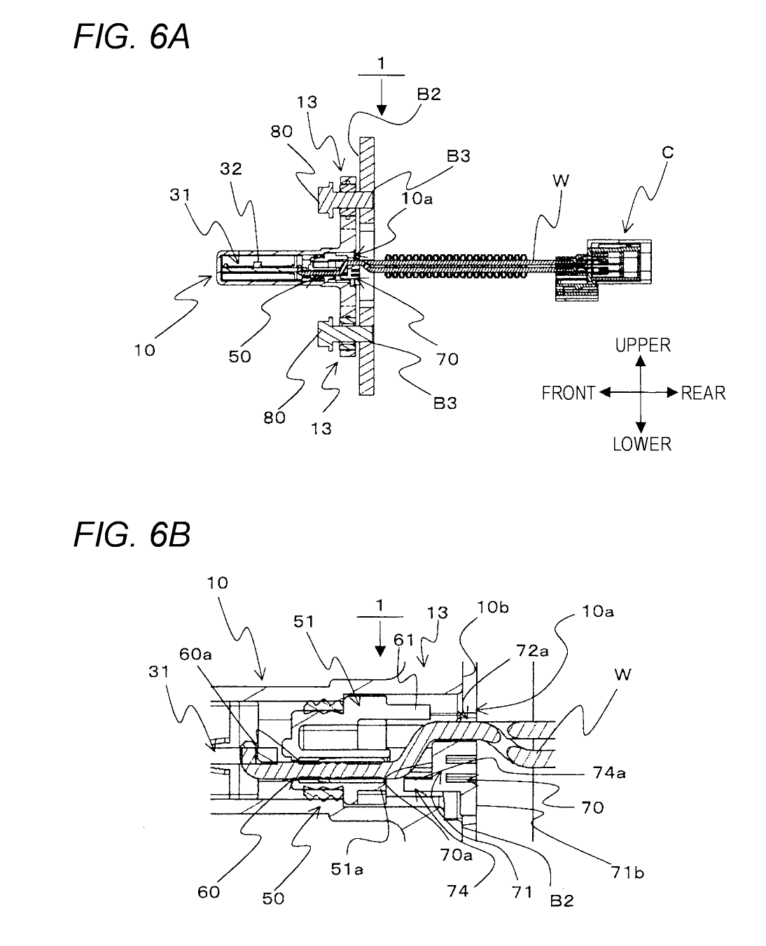

Thereafter, the operator starts the work of fitting the housing 10 to the body B (refer to FIGS. 6A and 6B). In the fitting work to the body B, a bolt 80 is inserted through the bolt hole 12c of the fixed portion 13 in the housing 10 and the body side bolt hole B3 to fasten the housing 10 with the bolt 80. A rear end surface 71 b of the guide base 71 is abutted against the fitting surface B2 by thus fastening the bolt 80, as a result of which the holder 70 is moved to the interior of the housing 10. More specifically, the holder 70 is moved while the rear end surface 71b of the guide base 71 is abutted against the fitting surface B2 over the wire harness insertion port B1 formed in the fitting surface B2 of the body B.

The holder 70 and the seal member 50 are brought close to each other by thus fastening the bolt 80 and moving the holder 70, the holding positions of the respective electric wires W are regulated by the protruded wire guide portion 74 to bend the respective electric wires W.

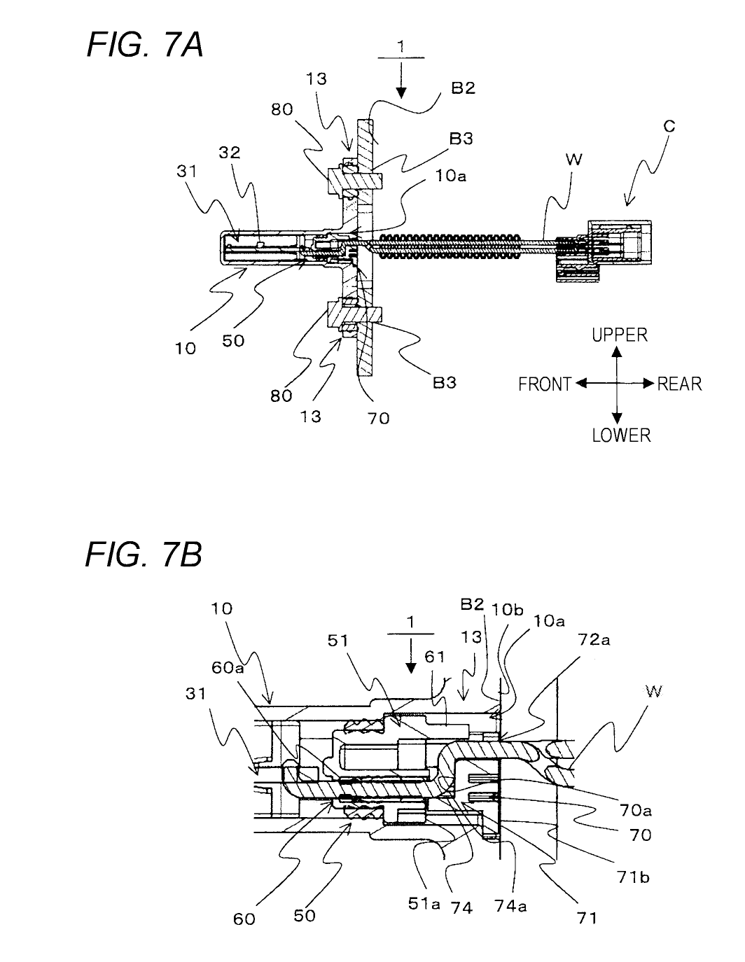

Thereafter, the operator completes the fastening of the bolt 80 to complete the work of fitting the housing 10 to the body B (refer to FIGS. 7A and 7B). Upon completion of the work of fitting the housing 10 to the body B, the respective electric wires W are held to be bent along the protrusion piece 61, the guide base 71, and the protruded wire guide portion 74 in a state where an opening end surface 10b of the housing 10 coincides with the rear end surface 71b of the guide base 71. That is, the strain relief structure is formed.

In the LED lighting unit 1 according to the embodiment of the present invention, when the work of fitting the housing 10 to the body B has been completed, that is, when the opening end surface 10b of the housing 10 coincides with the rear end surface 71 b of the guide base 71, the respective electric wires W are held within the housing 10 in the state where the respective electric wires W are bent along the protrusion piece 61 of the seal member 50, and the guide base 71 and the protruded wire guide portion 74 of the holder 70. That is, the strain relief structure is configured by the seal member 50 and the holder 70 by the work of fitting the housing 10 to the body B. Therefore, the assembling work can be facilitated while maintaining the waterproof performance and reducing the external load on the connection of the electric wire and the circuit board.

Also, in the LED lighting unit 1 according to the embodiment of the present invention, the protruded wire guide portion 74 has the wire guide grooves 74a whose cross section orthogonal to the longitudinal direction of the electric wires W forms the curved surface corresponding to the diameter of the electric wires W, and when the guide base 71 is inserted into the housing 10, the respective wire guide grooves 74a are arranged to face the insertion holes 60a. Therefore, the respective electric wires W can be surely guided by the wire guide grooves 74a with the result that a bending direction of the electric wires W can be more surely regulated.

Also, in the LED lighting unit 1 according to the embodiment of the present invention, the housing 10 has the fixed portion 13 fixed to the fitting surface B2 by the bolt 80, and when the fixed portion 13 is fixed to the fitting surface B2 by fastening the bolt 80, the holder 70 is moved and arranged at the given position within the housing 10 by abutting the rear end surface 71b of the guide base 71 against the fitting surface B2. This makes easy to install the LED lighting unit 1.

In the LED lighting unit 1 according to the embodiment of the present invention, the provision of four electric wires W is exemplified. However, the number of electric wires W is not limited to four. That is, if one or more electric wires W are provided, the number of electric wires W other than four may be employed.

Also, in the LED lighting unit 1 according to the embodiment of the present invention, the configuration in which the seal member 50 includes the annular seal member 54 and the cylindrical seal member 60b is exemplified. However, the present invention is not limited to this configuration. That is, the seal member 50 has only to provide the waterproof function. For example, if the seal member 50 is made of a material having a gap filling property, the waterproof performance can be enhanced without provision of the annular seal member 54 and the cylindrical seal member 60b.

Also, in the LED lighting unit 1 according to the embodiment of the present invention, the configuration in which the fitted portion is fastened to the fitting surface by the bolt 80 is exemplified. However, the present invention is not limited to this configuration. For example, the bolt 80 may be replaced with a screw.

In conclusion, the present invention made by the present inventors has been described in detail on the basis of the above-mentioned embodiment. However, the present invention is not limited to the above-mentioned embodiment, and can be variously modified without departing from the subject matter of the invention.

The present invention is useful for providing an LED lighting unit that can facilitate the assembling work while maintaining the waterproof performance and reducing an external load on the connection of the electric wire and the circuit board.

What is claimed is:

1. An LED lighting unit, comprising:
a housing which has a box shape including an opened surface formed with an opening and which is made of a light transmissive material;
a circuit board on which an LED element is mounted so that at least one electric wire having one end connected to the circuit board is led to external from the opening of the housing;
a seal member, arranged at a side of the opening relative to the circuit board, and including:
a seal main body configured to be inserted into the housing in an insertion direction;
a wire insertion portion formed with an insertion hole through which the electric wire to be inserted into the seal main body in the insertion direction;
a protrusion piece arranged at adjacent to the wire insertion portion, and protruded from a rear surface of the seal main body in a direction opposite to the insertion direction; and
a holder, arranged at a side of the opening of the housing relative to the seal member, and including:
a guide base configured to be inserted into the housing;
a protruded wire guide portion, protruded from a front end surface of the guide base in the insertion direction, and arranged at a position facing the wire insertion portion within the housing; and
a wire lead portion, configured to lead the electric wire from a position adjacent to the guide base to an external thereof,
wherein the opened surface of the housing coincides with a rear end surface of the guide base at a position within the housing.

2. The LED lighting unit as set forth in claim 1, wherein
the protruded wire guide portion has a wire guide groove,
the wire guide groove has a curved surface having a cross section corresponding to a diameter of the electric wire, and
when the guide base is inserted into the housing, the wire guide groove is arranged to face the insertion hole.

3. The LED lighting unit as set forth in claim 1, wherein
the housing includes a fixed portion configured to be fixed to a fitting surface of an object to be fitted by a fastening member, and
in a state where the fixed portion is fixed to the fitting surface, the rear end surface of the guide base comes in contact with the fitting surface of the object to be fitted so that the holder is arranged at a position within the housing.
